(19) United States
(12) Patent Application Publication
(10) Pub. No.: US 2010/0219265 A1
(43) Pub. Date: Sep. 2, 2010

(54) WATER IRRIGATION SYSTEM INCLUDING DRIP IRRIGATION EMITTERS

(76) Inventor: Tanhum Feld, Moshav Merhavia (IL)

Correspondence Address: MARTIN D. MOYNIHAN d/b/a PRTSI, INC., P.O. BOX 16446, ARLINGTON, VA, 22215, US

(21) Appl. No.: 12/668,029

(22) PCT Filed: Jul. 8, 2008
(86) PCT No.: PCT/IL08/00930

§ 371 Date: Jan. 7, 2010

Related U.S. Application Data
(60) Provisional application No. 60/929,692, filed on Jul. 9, 2007.
(60) Provisional application No. 61/064,543, filed on Mar. 11, 2008.

(51) Int. Cl. B05B 15/00

(52) U.S. Cl. 239/542

(57) ABSTRACT

A water irrigation system, includes a water supply tube for conducting water through its interior and formed with a plurality of outlet openings spaced along its length for distributing water to plants growing in soil along the length of the water supply tube; a plurality of drip irrigation emitters fixed within the water supply tube along the length thereof, each of the drip irrigation emitters including an inlet communicating with the interior of the water supply tube to receive water therefrom, and an outlet communicating with one of the outlet openings of the water supply tube for outletting therefrom water at a reduced pressure along spaced locations of the water supply tube; and a body of water absorbent material for contacting the water supply tube and its outlet openings for distributing the water to the soil to wet the soil along continuous strips.

### FIELD AND BACKGROUND OF THE INVENTION

The present invention relates to water irrigation systems, and particularly to a type which include drip irrigation emitters for irrigating plants with minimal and/or optimal water consumption.

One of the most popular methods for economical and efficient irrigation today is drip irrigation, wherein water is supplied through a pressurized water supply tube to the irrigated area and dripped from the pressurized tube to the soil via drip irrigation emitters that are spaced apart on top or inside along the tube. The flow rates from the drip irrigation emitters are determined by the water pressure if the drip irrigation emitters are not of the pressure-compensated type, or if of the pressure-compensated type, by a flow regulation integral mechanism inside the drip irrigation emitters, as well as by other properties of the drip irrigation emitters. The flow rates vary usually between 1 to 8 liters per hour per drip irrigation emitter.

Drip irrigation is used both on (on-surface) and below surface (sub-surface) of the ground. When placed sub surface (SDI), it is usually placed at a depth of 10-40 cm.

On-surface drip irrigation systems suffer from several disadvantages. One disadvantage is the loss of water due to evaporation from the surface. The dripping of water on the surface also creates mud that limits access of machinery to the irrigated area and encourages growth of weeds or causes technical limitations during the harvest time. These limitations are overcome by SDI.

Another limitation of drip irrigation, both on-surface and sub-surface, is uniformity of irrigation; the drip irrigation emitters are spaced apart and therefore irrigate in spots or bulbs. In order to make sure that all plants are irrigated, the soil is irrigated until the spots meet and an important part of the surface unnecessarily gets wet. This results in relatively inefficient irrigation due to loss of water through evaporation, losses due to gravity migration to a depth out of reach of the root systems, over wetting of the soil causing lack of oxygen, damage to the roots, and damages from over fertilizing by fertilizers included in the irrigating water. Alternatively the drip irrigation emitters can be spaced apart in smaller intervals enabling to shorten the irrigation points and thereby to improve irrigation efficiency. However, this will result in a more expensive system due to the larger number of drip irrigation emitters per meter.

Ideally the “wet spot” should be a relatively uniform narrow wet strip parallel to the water supply tube. Attempts have been made to develop a commercial “sweating” tube that will uniformly deliver water but so far unsuccessfully.

The need to wet a large part of the cultivated area causes numerous side effects such as inadequate ventilation to the ground that may damage the plants and encourage growth of bacteria, lack of oxygen, create good conditions for soil diseases etc.

The intervals between irrigations may cause lack of water to the plant in between irrigations; at hot hours, this will cause stress to the plants and slow their development.

Yet another limitation of drip irrigation is clogging (occlusion) of the drip emitters both by plants roots and by dirt. Clogging is caused by suction of dirt into the drip irrigation emitter which is created when the water supply is shut down whereupon the pressure inside the tube may drop to a negative value. There is therefore a need to protect the drip irrigation emitter's openings from dirt or roots penetration.

A still further limitation of drip irrigation is particularly present in sandy soils where water flows faster into the depth of the soil due to gravity and the chemical characteristics of the sandy soils (absence of clay, silt, or organic matter). In such cases, there is a lot less horizontal flow. This makes it hard for the wet spots to meet. With the growing need for land for cultivation it is desirable to provide an irrigation system that will enable cultivation of sandy or otherwise inadequate marginal soils.

### OBJECTS AND BRIEF SUMMARY OF THE PRESENT INVENTION

An object of the present invention is to provide an on-surface or sub-surface irrigation system having advantages in one or more of the above respects.

According to a broad aspect of the present invention, there is provided a water irrigation system, comprising: a water supply tube for conducting water through its interior and formed with a plurality of outlet openings spaced along its length for distributing water to plants growing in soil along the length of the water supply tube; a plurality of drip irrigation emitters fixed within the water supply tube along the length thereof, each of the drip irrigation emitters including an inlet communicating with the interior of the water supply tube to receive water therefrom, and an outlet communicating with one of the outlet openings of the water supply tube for outletting therefrom water at a reduced pressure along spaced locations of the water supply tube; and a body of water absorbent material in contact with the water supply tube and its outlet openings for distributing the water to the soil to wet the soil along continuous strips.

In one described preferred embodiment, the outlet openings are formed along the water supply tube, and the body of water absorbent material encloses the water outlet openings thereat. Such a construction is particularly useful in an under-ground water irrigation system.

Another embodiment is described wherein the body of water absorbent material encloses the complete outer surface of the water supply tube. Such a construction may be used both in above-ground and under-ground water irrigation systems.

According to a further feature in another described preferred embodiment, the outer surface of the body of water absorbent material is enclosed by a water-permeable outer protective layer, such as perforated plastic layer, or a textile-fiber layer.

According to a further feature included in the described preferred embodiments, the body of water absorbent material is sufficiently dense to substantially prevent clogging of the outlet openings in the water supply tube.

The water absorbent material may include a body of textile fibers, such as cotton or polyester resin, or other absorbent material, such as a porous material formed with open pores. In one described embodiment, the water absorbent material is of textile fibers of a hydrophilic material, alone, or with an outer layer of a hydrophobic material.

According to a further aspect of the present invention, there is provided a water irrigation system, comprising: a water supply tube for conducting water through its interior and formed with a plurality of outlet openings spaced along its length for distributing water to plants growing in soil along the length of the water supply tube; a plurality of drip irrigation emitters fixed within the water supply tube along the length thereof, each of the drip irrigation emitters including an inlet communicating with the interior of the water supply tube to receive water therefrom, and an outlet communicating with one of the outlet openings of the water supply tube for outletting therefrom water at a reduced pressure along spaced locations of the water supply tube; each of the drip irrigation emitters being bonded to the inner surface of the water supply tube and extending for less than one-half its inner circumference; and a body of water absorbent material enclosing at least the lower outer surface of the water supply tube and the outlet openings thereat for distributing the water to the soil to wet the soil along continuous strips.

According to a further aspect of the present invention, the body of water absorbent material can be used as carrier for fertilizers, growth prevention chemicals, pesticides, bactericides, or other additives. These additives are either combined as components in the material for forming it, or are added to it after it is formed or after it is assembled on the water supply tube.

Further features and advantages of the invention will be apparent from the description below.

### BRIEF DESCRIPTION OF THE DRAWINGS

The invention is herein described, by way of example only, with reference to the accompanying drawings, wherein:

FIGS. 1a and 1b schematically illustrate prior art irrigation systems in plan and side elevation, respectively;

FIGS. 2a and 2b schematically illustrate a sub-ground and on-ground drip irrigation system constructed in accordance with the present invention, respectively;

FIG. 3a illustrates one form of water supply tube constructed in accordance with the present invention;

FIG. 3b is a cross sectional view of FIG. 3a;

and FIG. 3c illustrates a variation in FIG. 3b;

FIGS. 4a and 4b are schematical elevational and end views, respectively, illustrating an under-ground irrigation system constructed in accordance with the present invention;

FIGS. 4c and 4d are enlarged sectional views of a section of the system illustrated in FIGS. 4a and 4b;

FIG. 5a is a schematic view illustrating another irrigation system constructed in accordance with the present invention; and

FIG. 5b is an enlarged fragmentary view of the system of FIG. 5a.

It is to be understood that the foregoing drawings, and the description below, are provided primarily for purposes of facilitating understanding the conceptual aspects of the invention and possible embodiments thereof, including what is presently considered to be a preferred embodiment. In the interest of clarity and brevity, no attempt is made to provide more details than necessary to enable one skilled in the art, using routine skill and design, to understand and practice the described invention. It is to be further understood that the embodiments described are for purposes of example only, and that the invention is capable of being embodied in other forms and applications than described herein.

### THE PRIOR ART

The present invention may utilize any of the known drip irrigation emitter constructions, commonly used in water irrigation to feed the water directly to the roots of the plants. Such drip irrigation emitters are bonded to the inner surface of a water supply tube at spaced locations along the length of the tube. Each drip irrigation emitter includes an inlet communicating with the pressurized water in the interior of the tube, a labyrinth or other pressure-dropping construction for reducing the pressure of the water, and an outlet communicating with an outlet opening of the water supply tube for discharging the water at the reduced pressure, and therefore at a slow flow rate. Preferably, the drip irrigation emitters used in the systems constructed in accordance with the present invention are of the pressure-compensated type, which produces a generally constant output pressure at the outlet end of each emitter, irrespective of the inlet pressure.

Since such drip irrigation emitters are well known and widely used at the present time, no further details of the construction or operation of such emitters is set forth herein.

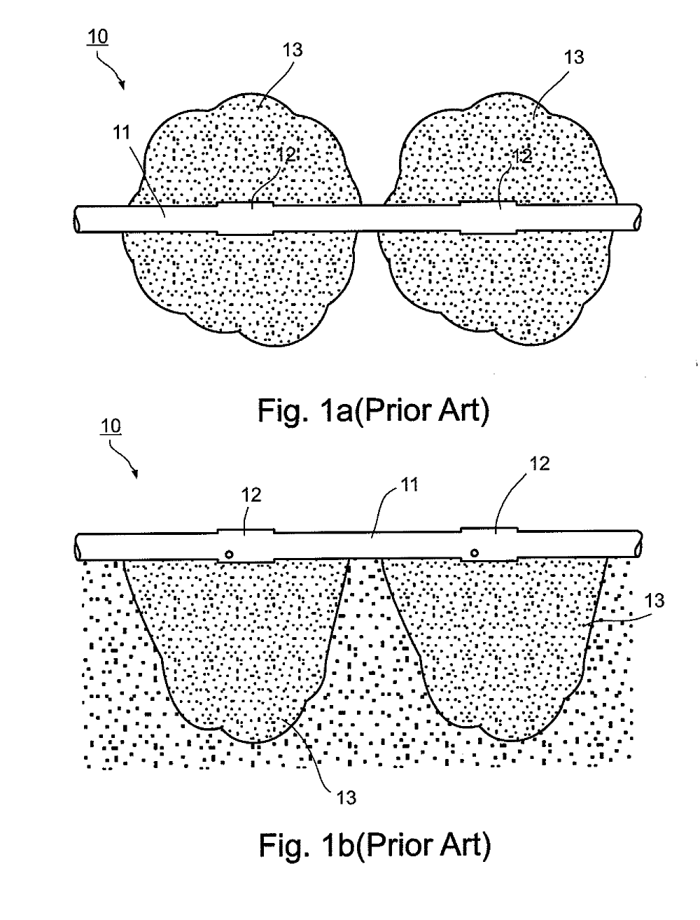

FIG. 1a schematically illustrates a top view of a prior art drip irrigation system, generally designated 10 placed on the surface of the ground, including a water supply line 11 with spaced apart drip irrigation emitters 12, each producing a “wet spot” 13 representing the irrigated area. Since the drip irrigation emitters are spaced apart, the wet spots are round spots around the drip irrigation emitters. The plants are planted unrelated to the exact location of the drip irrigation emitters along the drip line. In order to make sure that all plants are irrigated it is necessary to irrigate until the wet spots substantially meet. The radius of the wet spots should therefore be more than half the distance between two adjacent drip irrigation emitters. If the drip irrigation emitters are spaced relatively far from each other then the wet spot radius is correspondingly large, and the wet area will be wider then necessary. Alternatively if the drip irrigation emitters are relatively close to each other then the radius of the wet spot is smaller, but the cost of the irrigation system is higher because of the larger number of drip irrigation emitters needed.

In addition, the drip irrigation emitters' outlets are exposed and could therefore be clogged by dirt or roots. This is especially important when the drip irrigation emitter line is buried in the ground, but also when placed on the ground.

FIG. 1b illustrates the same system in a cross sectional view of the ground. The same principles shown in the description of FIG. 1a apply here; the larger the distance between the drip irrigation emitters, the deeper are the wet spots. The depth of the wet spots depends also on the properties of the soil. If the soil has high water retention capacity, then the depth of the wet spot will be smaller. If the soil has low water retention capacity, then the depth of the spot will be higher. In an extreme case as in sandy soil the wet spots will not be able to meet unless the drip irrigation emitters are extremely close to each other, since the seeping or draining rate may be sufficiently large to reduce the horizontal progress of the irrigating water.

### Preferred Embodiments of the Invention

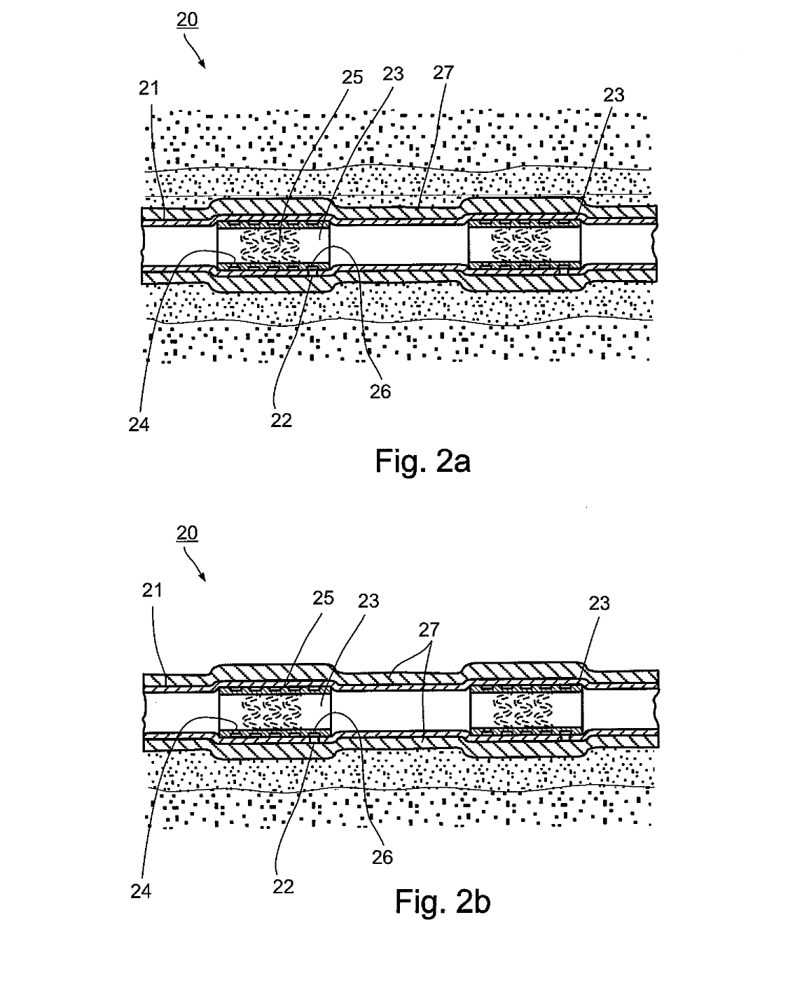

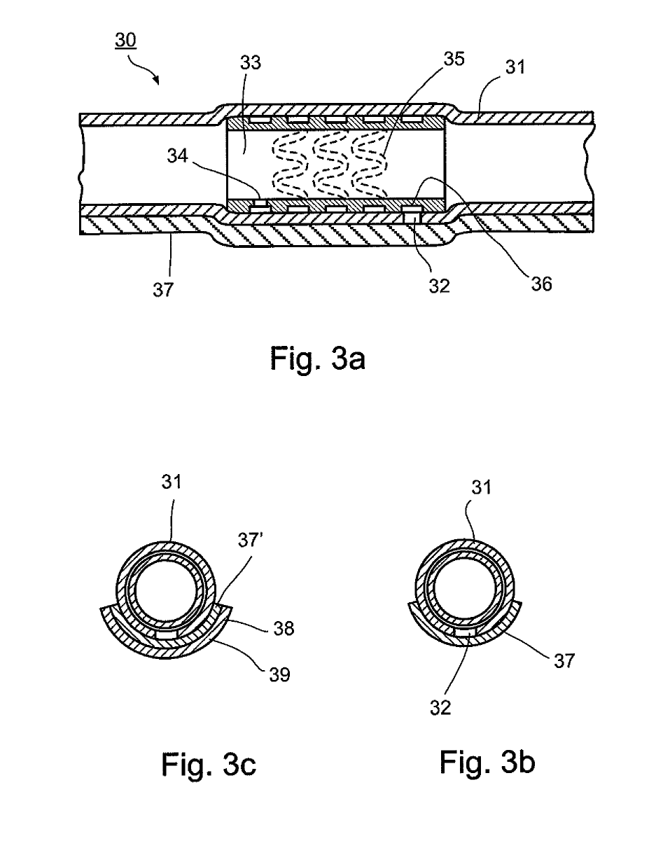

FIGS. 2a and 2b are schematical top and side view, respectively, illustrating a water irrigation system in a cross section constructed in accordance with the present invention, whereas FIGS. 3a-3c are views more particularly illustrating the construction of the system at each of the locations of the water supply tube receiving a drip irrigation emitter.

Thus, as shown in FIGS. 2a and 2b, the water irrigation system, generally designated 20, includes a water supply tube 21 for conducting water through its interior, and formed with a plurality of outlet openings 22 spaced along its length for distributing the water to plants (not shown) growing in the soil along the length of the water supply tube. The water irrigation system 20 further includes a plurality of drip irrigation emitters 23, each having an inlet 24 exposed to the water within the water supply tube 21, a labyrinth or other restrictor construction 25 for reducing the pressure of the water conducted through the drip irrigation emitter, and an outlet 26 communicating with an outlet 22 of the water supply tube for outletting water from the drip irrigation emitter at a reduced pressure, and therefore at a slow rate.

Such a construction of a water supply tube include a plurality of drip irrigation emitters, commonly called a drip irrigation emitter tube, is well known, but its use has disadvantages as briefly discussed above.

According to the present invention, the water supply system further includes a body of water absorbent material, generally designated 27, for contacting at least part of the water supply tube 21 and its outlet opening 22 for distributing the water to the soil to wet the soil in continuous strips, rather than in individual circular configurations, as described above with respect to FIGS. 1a and 1b.

While the water absorbent body 27 may take many forms, FIGS. 2a and 2b illustrate this body 27 as enclosing the complete outer surface of the water supply tube 21. While such a construction may also be used above ground, it is particularly useful below ground, since the water absorbent body 27 wets the soil along its complete circumferential surface to produce wet strips along the length of the water supply tube.

FIGS. 3a and 3b illustrate another water supply system constructed in accordance with the present invention, therein generally designated 30, also including a water supply tube 31 formed with a plurality of outlet openings 32 along its length, and a water irrigation emitter 33 bonded to its inner surface. Emitter 33 may be of a conventional construction including an inlet 34 communicating with the interior of the water supply tube 31, a labyrinth 35 for dropping the pressure of the water entering the emitter, and an outlet 36 communicating with an outlet 32 of the water supply tube 31, outletting the water, after having experienced a drop in pressure by the labyrinth 35, at a slow rate through the tube outlet opening 32.

The construction illustrated in FIGS. 3a and 3b further includes a body of water absorbent material for distributing the outletted water to the soil in the form of a continuous wetted strip along the length of the water supply tube.

In the construction illustrated in FIGS. 3a and 3b, the body of water absorbent material 37 is of substantially semi-circular configuration and encloses only the bottom surface of the water supply tube 31, as well as its outlet opening 32. Such a construction is particularly useful for below-the-ground irrigation since the soil surrounds the irrigation system and is always in contact with the water absorbent body 37 of semi-cylindrical configuration.

In both of the embodiments described above with respect to FIGS. 2a, 2b and 3a, 3b, the body of water absorbent material (27, 37) may be of a polymer with a high level of absorption properties or textile fiber, such as cotton and/or polyester resin. It may also be of a porous material, such as a spongy plastic body formed with open pores, or any other construction capable of absorbing and retaining the water exiting from the outlet opening in the water supply tube and distributing the water along the length of the tube. Preferably, this body is sufficiently dense to substantially prevent clogging of the outlet openings (e.g. 32) in the water supply tube (e.g. 31) by dirt or plants roots.

FIG. 3c illustrates a modified construction wherein the water absorbent body, therein designated 37′, is also of semi-cylindrical construction to cover only the under surface of the water supply tube 31, but is constituted of two layers 38 and 39. The inner layer 38 may be one having hydrophilic properties, such as cotton fibers, and the outer layer may be one having hydrophobic properties, such as filaments of polyester resin, etc.

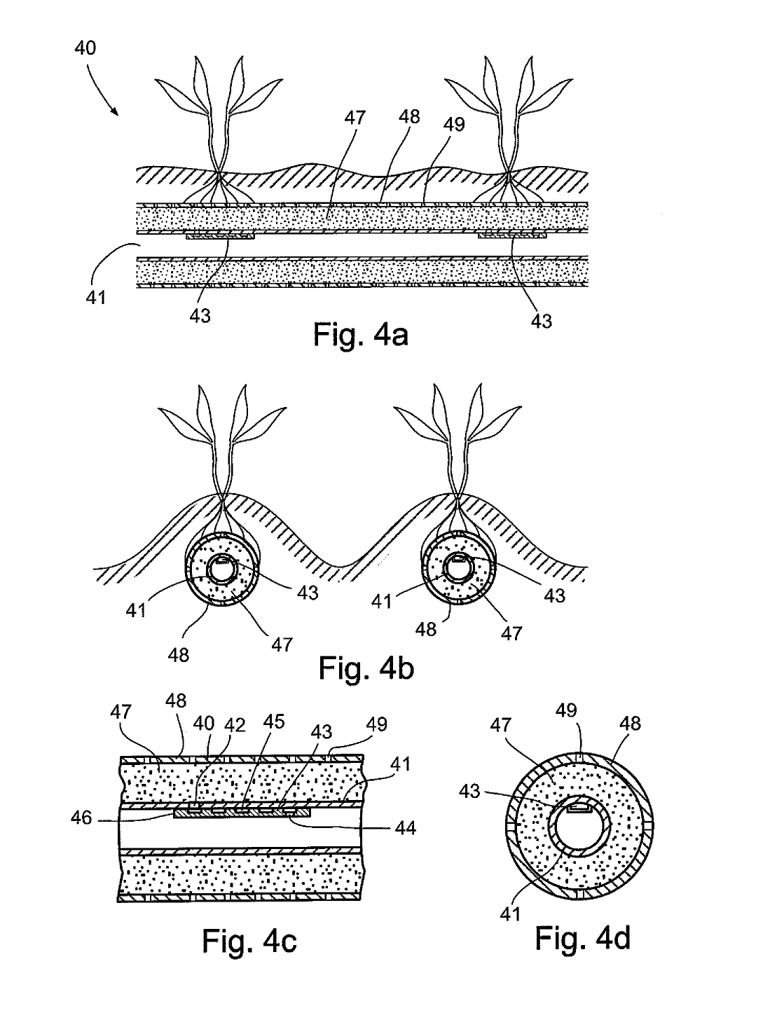

FIGS. 4a-4d illustrates another water supply system constructed in accordance with the present invention. As thus seen from FIGS. 4c and 4d, the system includes a water supply tube 41 formed with a plurality of outlet openings 42 along its length, and a drip irrigation emitter 43 bonded to the inner face of the water supply tube and spaced at longitudinal locations along the tube. Each drip irrigation emitter 43 includes an inlet 44 communicating with the interior of the water supply tube, a labyrinth 45, or other restrictor, for dropping the pressure of the water flowing through the emitter, and an outlet 46 communicating with an outlet opening 42 in the water supply tube for supplying water externally of the tube at a slow rate. As described above with respect to FIGS. 2a and 2b, the water supply tube 41 is completely enclosed by a body of water absorbent material 47 for causing the outletted water to wet the soil in the form of continuous strips along the length of the water supply tube.

As distinguished from the previously-described embodiments, however, the water supply system 40 illustrated in FIGS. 4a-4d also includes an outer water-permeable protective layer 48 enclosing the body of water absorbent material 47. In the example illustrated in FIGS. 4a-4d, as shown particularly in FIGS. 4c and 4d, the outer water-permeable layer 48 is preferably of a plastic material, such as polyethylene, formed with a plurality of perforations 49 for establishing communication between the water absorbent material 47 and the soil in which the water supply tube 41 is embedded, as shown in FIGS. 4a and 4b.

As shown particularly in FIG. 4d, the drip irrigation emitters 43 are of the relative “flat” type, extending for less than one-half circumference of the internal surface of the water supply tube so as to provide a larger area for the flow of pressurized water to the interior of the water supply tube.

While the outer water-permeable protective layer as shown in FIG. 4c has been of a perforated plastic material, it will be appreciated that it could also be of a fibrous material, such as a cotton or polyester fiber, providing pores for uplifting the water from the water absorbent body 47 to the soil in the form of wetted strips.

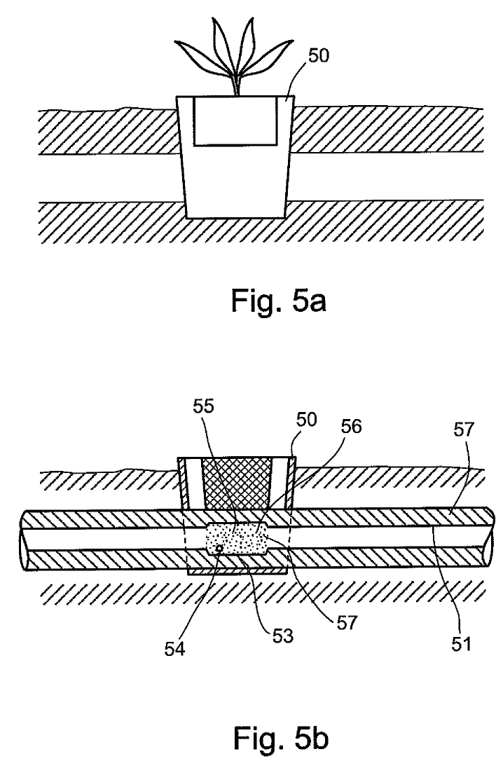

FIGS. 5a and 5b illustrate a water irrigation system similar to that of FIGS. 4a-4d, for example, but used for irrigating plants growing in pots, therein generally designated 50. Thus, the water supply system illustrated in FIGS. 5a and 5b also include a water supply tube 51, extending above the ground or under the ground, through each of the pots 50. The water supply tube 51 includes a plurality of outlet openings 52, at least one location within each pot 50, and also a plurality of drip irrigation emitters 53, at least one being located so as to be disposed within each pot 50. The water irrigation emitters 53 may be of any of the above-described types, including an inlet 54, a labyrinth 55, and an outlet opening 56 in alignment with an outlet opening 52 in the water supply tube 51.

The water supply tube 51 further includes a body of water absorbent material 57 enclosing the water supply tube 51. It may also include an outer protective layer formed with a plurality of outlet openings, corresponding to layer 48 and openings 49 in FIGS. 4c, 4d, at least some of which are located within the respective pot 50, for wetting the soil within the respective pot.

While the invention has been described with respect to several preferred embodiments, it will be appreciated that these are set forth merely for purposes of example only, and that many variations may be made. For example, the water absorbent body need not be carried by the water supply tube, but could be in the form of a continuous net extending under the water supply tube. In addition, other water absorbent materials could be used than those described above for purposes of example. In addition, the water used for irrigation purposes can include many types of additives commonly included in irrigation water.

Many other variations, modifications and applications of the invention will be apparent.

What is claimed is:

1. A water irrigation system, comprising:
a water supply tube for conducting water through its interior and formed with a plurality of outlet openings spaced along its length for distributing water to plants growing in soil along the length of the water supply tube;
a plurality of drip irrigation emitters fixed within the water supply tube along the length thereof, each of said drip irrigation emitters including an inlet communicating with the interior of the water supply tube to receive water therefrom, and an outlet communicating with one of said outlet openings of the water supply tube for outletting therefrom water at a reduced pressure along spaced locations of the water supply tube;
and a body of water absorbent material in contact with the water supply tube and its outlet openings for distributing the water to the soil to wet the soil along continuous strips.

2. The system according to claim 1, wherein said body of water absorbent material encloses at least part of the outer surface of said water supply tube and the outlet openings thereat.

3. The system according to claim 1, wherein said body of water absorbent material completely encloses the outer surface of the said water supply tube.

4. The system according to claim 3, wherein the outer surface of said body of water absorbent material is enclosed by a water-permeable protective layer.

5. The system according to claim 4, wherein said water-permeable protective layer is perforated plastic.

6. The system according to claim 4, wherein said water-permeable protective layer is of a textile fiber.

7. The system according to claim 1, wherein said body of water absorbent material is sufficiently dense to substantially prevent clogging of the outlet openings in the water supply tube.

8. The system according to claim 1, wherein said body of water absorbent material is or includes a water absorbing polymers.

9. The system according to claim 1, wherein said body of water absorbent material is or includes a body of textile fiber.

10. The system according to claim 9, wherein said body of textile fiber is of cotton or of a polyester resin.

11. The system according to claim 9, wherein said textile fiber has hydrophilic properties.

12. The system according to claim 9, wherein said textile fiber includes an inner layer having hydrophilic properties, and an outer layer having hydrophobic properties.

13. The system according to claim 1, wherein said body of water absorbent material is of a porous material formed with open pores.

14. The system according to claim 1, wherein said drip irrigation emitter is bonded to the inner surface of said water supply tube and extends for less than one half of its inner circumference.

15. The system according to claim 1, wherein said plants are grown in soil within pots embedded in the soil, and said water supply extends through said pots.

16. The system according to claim 1, wherein the body of water absorbent material is utilized as a carrier for fertilizers, growth prevention chemicals, pesticides, bactericides, or other additives.

17. A water irrigation system, comprising:
a water supply tube for conducting water through its interior and formed with a plurality of outlet openings spaced along its length for distributing water to plants growing in soil along the length of the water supply tube;
a plurality of drip irrigation emitters fixed within the water supply tube along the length thereof, each of said drip irrigation emitters including an inlet communicating with the interior of the water supply tube to receive water therefrom, and an outlet communicating with one of said outlet openings of the water supply tube for outletting therefrom water at a reduced pressure along spaced locations of the water supply tube;
each of said drip irrigation emitters being bonded to the inner surface of said water supply tube and extending for less than one-half its inner circumference;
and a body of water absorbent material enclosing at least the lower outer surface of said water supply tube and the outlet openings thereat for distributing the water to the soil to wet the soil along continuous strips.

18. The system according to claim 17, wherein the outer surface of said body of water absorbent material is enclosed by a water-permeable protective layer.

19. (canceled)

20. The system according to claim 18, wherein said body of water absorbent material is or includes a body of textile fiber.

21. The system according to claim 18, wherein said body of water absorbent material completely encloses the outer surface of the said water supply tube.
